(19) United States
(12) Patent Application Publication
(10) Pub. No.: US 2023/0132186 A1
(43) Pub. Date: Apr. 27, 2023

(54) SELF-SERVE, AUTOMATED FEED DISPENSER

(71) Applicant: BB SILO S.E.N.C. BAIT BIN, Clarendon (CA)

(72) Inventors: Scott LEMAY, Clarendon (CA); Ralph LANG, Clarendon (CA)

(21) Appl. No.: 17/973,911

(22) Filed: Oct. 26, 2022

Related U.S. Application Data
(60) Provisional application No. 63/272,296, filed on Oct. 27, 2021.

(51) Int. Cl. A01K 5/02

(52) U.S. Cl. CPC A01K 5/0275; A01K 5/0225

(57) ABSTRACT

The present invention provides a self-serve, automated feed dispenser comprising a storage bin for the bulk free flowing particulate material; a conveying unit for conveying the bulk free flowing particulate material from the storage bin to an outlet; a user interface for selecting amount of said bulk free flowing material to be dispensed and optionally a means to input payment; and operation control means for operating the conveying unit in accordance with input from said user interface.

### FIELD OF THE INVENTION

The present invention pertains to a vending machine for dispensing bulk particulate materials, such as feed, dispenser.

### BACKGROUND OF THE INVENTION

Animal baiting, such as deer baiting, refers to the process of strategically placing a pile of food near hunting blinds or clearings in hopes of luring an animal (such as deer) into close range. Animal bait, such as deer bait, is available for purchase in numerous stores, particularly in rural areas during hunting season. The type of bait used may be dependent on the animal being baited. For example, a widely used bait for attracting whitetail deer is corn. Hunting trips may commence at early hours of the day, well before opening times of many retail shops and garages. Accordingly, there may be a need for bait to be purchased by consumers at times of the day when more traditional outlets for bait are closed.

Animal feed dispensers may also be used in non-hunting settings including feeding of domestic or wild animals including birds or cattle.

Many public areas are fitted with machines for vending food, beverages and other small items. In known vending machine designs, each item available for purchase has a purchase price and is dispensed when sufficient funds have been inserted. Many vending machines dispense pre-packaged items. Given that the amount of bait required by a hunter may vary, bait sold on a bulk basis may be preferred. While bulk vending machines are known in the art, many of these machines are coin operated machines which dispense small amounts of particulate materials, such as a snack size amount of candy or nuts.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a self-serve, automated feed dispenser. In accordance with an aspect of the present invention, there is provided an automated dispenser of bulk free flowing particulate material, the automated dispenser comprising: a storage bin for the bulk free flowing particulate material; a conveying unit for conveying the bulk free flowing particulate material from the storage bin to an outlet; a user interface for selecting amount of said bulk free flowing material to be dispensed and optionally a means to input payment; and operation control means for operating the conveying unit in accordance with input from said user interface. In some embodiments, the self-serve, automated feed is portable.

In accordance with certain embodiments of the invention, the dispenser is for dispensing animal feed.

In accordance with certain embodiments of the invention, the conveying unit is an auger system.

In accordance with certain embodiments of the invention, the dispenser further comprising a payment system for debit card, credit card and mobile/digital payment; the payment system operably associated with the user interface and operation control means and capable of communication with a payment processor.

In accordance with certain embodiments of the invention, the payment system is a contactless self-serve point of sale system.

In accordance with certain embodiments of the invention, the operation control means comprises a processor and a computer-readable storage medium that comprises one or more programming instructions that, when executed, cause the processor to: receive an indication of amount of bulk free-flowing particulate materials to be dispensed; receive confirmation from the POS system that payment has been made; and cause operation of the conveying unit for a sufficient period of time to dispense the amount of bulk free-flowing particulate materials requested.

In accordance with certain embodiments of the invention, the dispenser comprises one or more sensors and the operation control means receives further input from one or more sensors in the dispenser.

In accordance with certain embodiments of the invention, the computer-readable storage medium of the operation control means comprises one or more programming instructions that, when executed, cause the processor to: receive an indication of amount of bulk free-flowing particulate materials to be dispensed; receive confirmation from the POS system that payment has been made; and cause operation of the conveying unit by causing the motor of the conveying unit to start; receive input from one or more sensors that the amount of bulk free-flowing particulate materials requested has been dispensed; cause operation of the conveying unit to stop by causing the motor of the conveying unit to stop.

### BRIEF DESCRIPTION OF THE FIGURES

FIG. 1 provides a photograph of the front view a feed dispenser of an embodiment of the present invention.

FIG. 2 provides an isometric view of a feed dispenser of an embodiment of the present invention.

FIG. 3 provides a view of the control interface and the feed outlet of an embodiment of the present invention.

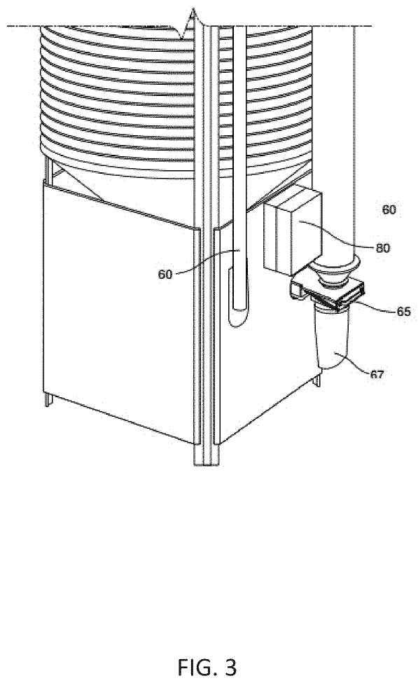

FIG. 4 provides a view of the feed outlet with grain release trap of an embodiment of the present invention.

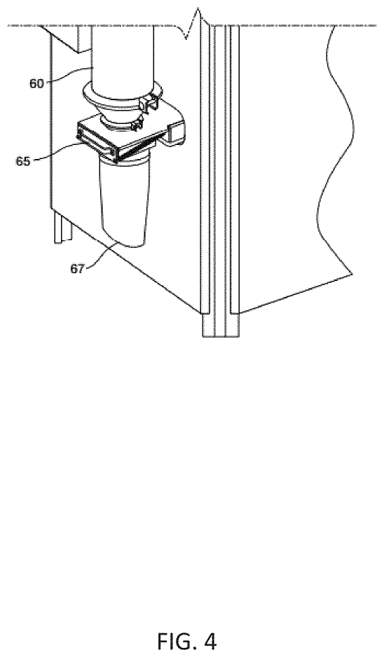

FIG. 5 provides a line drawing of the front view of a feed dispenser of an embodiment of the present invention.

FIG. 6 provides line drawings of a feed dispenser of an embodiment of the present invention detailing maintenance door.

FIG. 7 provides line drawings of a feed dispenser of an embodiment of the present invention (side view with maintenance door opened) showing internal auger system.

FIG. 8 provides line drawings of the motor auger assembly of an embodiment of the present invention.

FIG. 9 provides line drawing of the motor auger assembly of an embodiment of the present invention installed.

FIG. 10 provides photographs of a programmable logic controller (PLC) of a dispenser bin of an embodiment of the present invention.

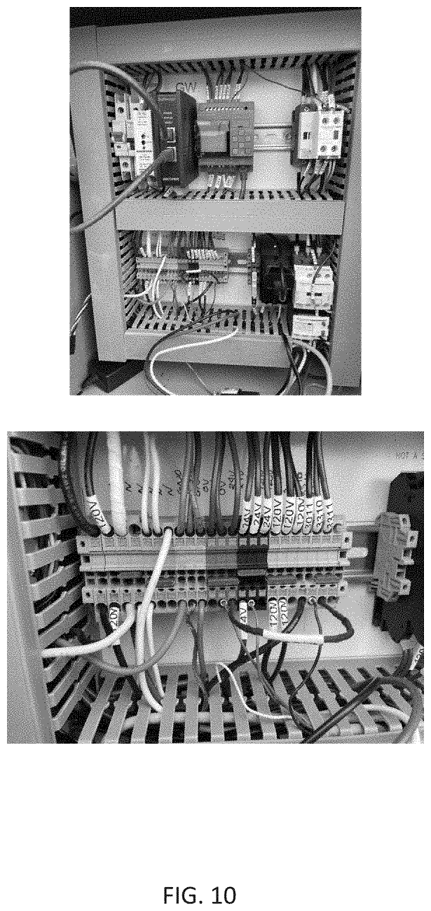

FIG. 11 provides network layout (top) and enclosure layout (bottom).

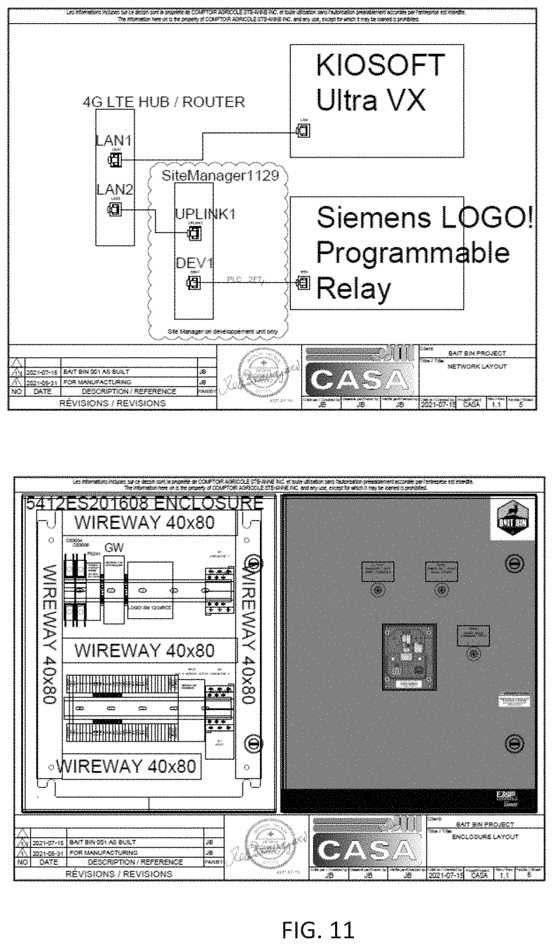

FIG. 12 provides an exemplary payment interface.

### DETAILED DESCRIPTION OF THE INVENTION

The present invention relates to a machine for dispensing bulk free-flowing particulate materials. In certain embodiments, the present invention relates to a self-serve, automated dispenser of bulk free-flowing particulate materials. The bulk free-flowing particulate materials may include for example grain, such as corn or animal feed pellets. In certain embodiments, the machine is for dispensing grain-based hunting bait or animal feed. In specific embodiments, the machine is for dispensing dried corn animal feed. In other embodiments, the machine is for dispensing seeds including bird seed mixes. In still further embodiments, the machine is for custom feed mixes.

In still further embodiments, the machine dispenses non-feed material including wood pellets or other flowable product including sand or soil.

The machine is optionally sized based on the material it is dispensing.

Accordingly, in certain embodiments the invention provides an automated dispenser of bulk free flowing particulate material, the automated dispenser comprising a storage bin for the bulk free particulate flowing material; a conveying unit for conveying the bulk free flowing particulate material from the storage bin to an outlet; a user interface for selecting amount of said bulk free flowing material to be dispensed and optionally a means to input payment; and operation control means for operating the conveying unit in accordance with input from said user interface. In certain embodiments, the dispenser further comprises a payment system operably associated with the user interface and operation control means.

In certain embodiments, the storage bin comprises a grain bin. Various types of grain storage bins constructed from a variety of rigid materials, such as steel or plastic, may be used in the automated dispenser of the present invention. The storage bins may include for example a bin with a hopper bottom. Accordingly, in certain embodiments of the dispenser of the present invention, the bin comprises a hollow cylindrical structure having a roof which is reversibly or irreversibly attached and an inverted hollow cone as the base. In certain embodiments, the bin comprises one or more openings. The one or more openings may include for example an opening at the apex of the inverted hollow cone base, an opening in the roof and one or more inlets or outlets including, for example, a re-fill inlet, and vents. The bin may be mounted on a support structure.

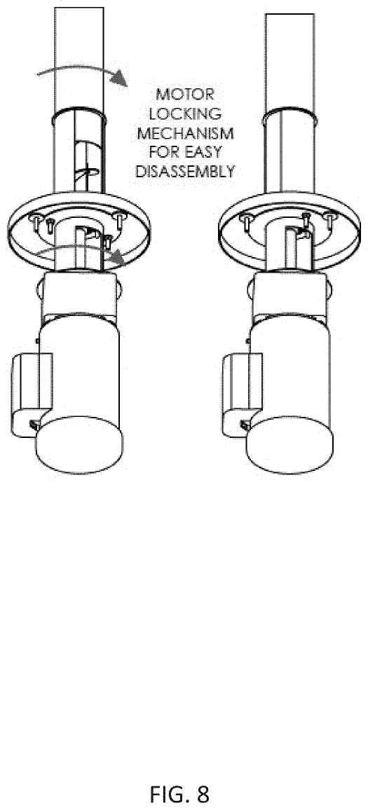

In certain embodiments, the conveying unit is a substantially vertical conveying unit which may be substantially inside the bin or substantially external to the bin. In certain embodiments, the conveying system comprises an auger system. The auger system comprises a spiral blade coiled around a shaft, the shaft is operatively connected to a motor, optionally a direct drive motor. In certain embodiments, a motor locking mechanism is utilized to reversibly connect the shaft to the motor. A non-limiting illustrative of a motor locking mechanism is utilized to reversibly connect the shaft to the motor is provided in FIG. 8. The spiral blade shaft assembly may be housed in a tube.

Accordingly, in certain embodiments, the auger system comprises a tube containing a spiral blade coiled around a shaft operatively connected to a motor. In certain embodiments, the auger system is substantially inside the storage bin. In certain embodiments, the auger system extends through the centre of the storage bin and is used to move the grain upwards.

In embodiments of an auger system which comprise a tube, the tube comprises one or more openings near the bottom of the tube to allow grain to enter the auger system and be transported up and further comprises one or more opening near the top of the tube to allow grain to exit the auger system. A worker skilled in the art would readily appreciate what materials may be used in the construction of the auger system. In certain embodiments, the shaft, blade and tube of the auger system are constructed from a metal, such as steel. A worker skilled in the art would further appreciate that auger systems for use in the dispenser of the present invention may be commercially available.

In some embodiments, the dispenser is portable. Optionally, the portable dispenser is installed on trailer. In some embodiments, the trailer is a low-profile trailer. In some embodiments, the trailer is configured that once parked the tires are removed or otherwise locked in place, the trailer is leveled and stabilized with hydraulic jacks. Such embodiments may be re-located when no longer needed at a specific location.

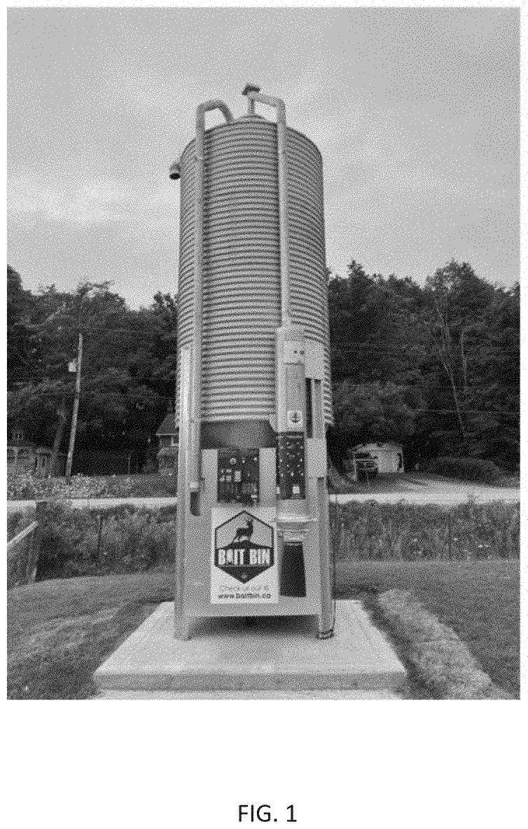

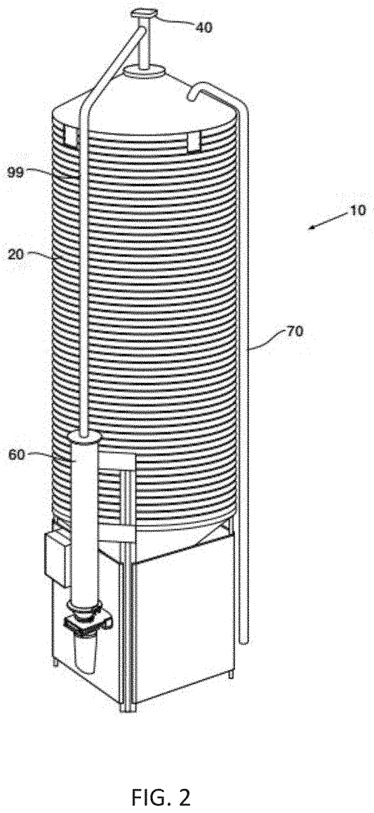

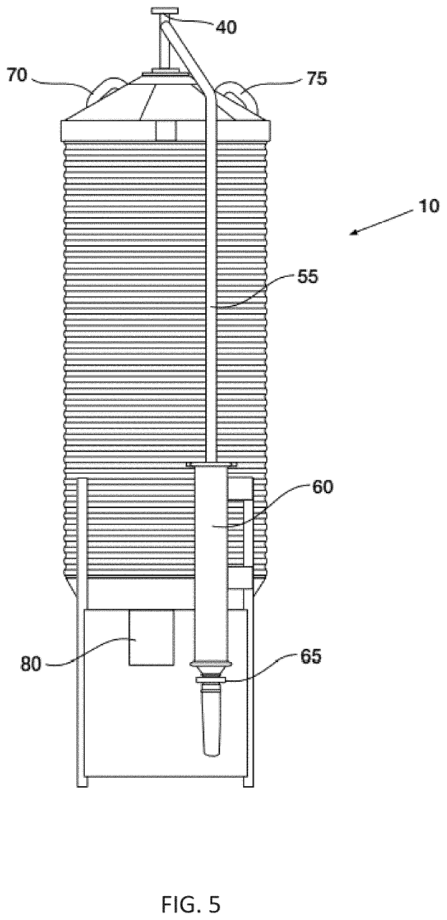

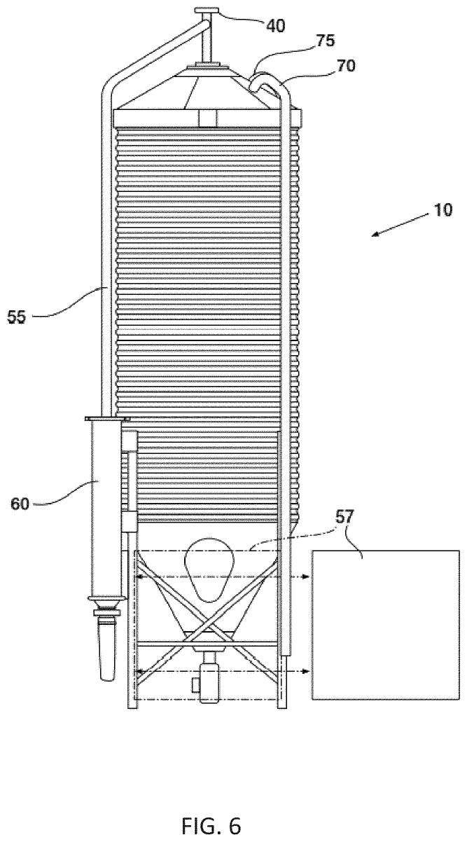

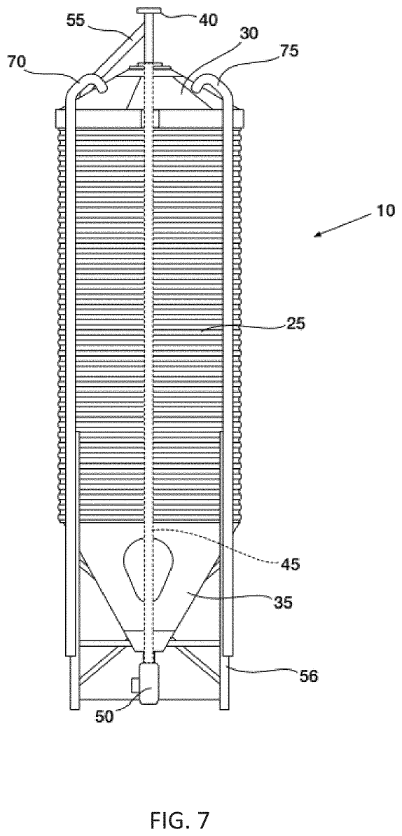

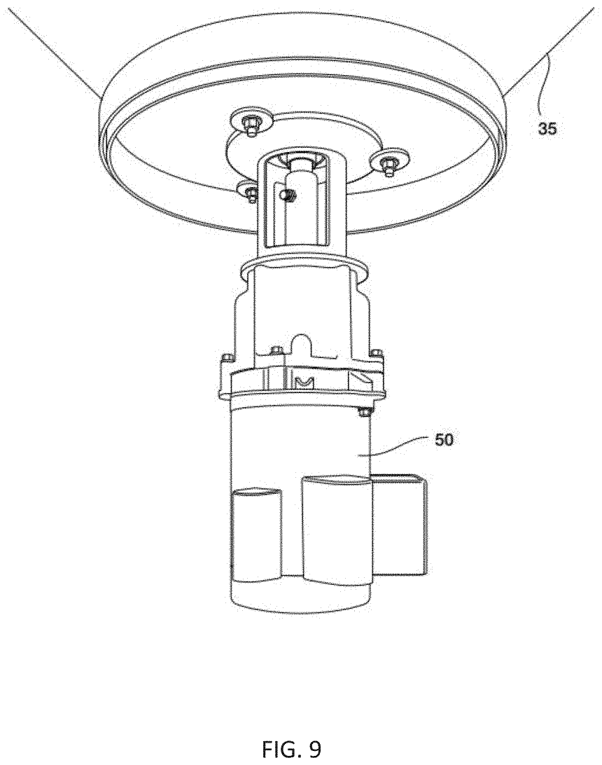

In the illustrative embodiment of the dispenser (10) set forth in FIGS. 1, 2, 5, 6, 7 and 9, the bin (20) comprises a hollow cylindrical structure (25) having a lid (30) with an opening and a hopper bottom (35) (i.e., an inverted cone with an opening at the apex of the cone) and a vertical conveying unit (40). The vertical conveying unit comprising an auger system (45). The auger system comprising a tube containing a spiral blade coned around a shaft operatively connected to a direct drive motor. The tube of the auger system (auger tube) extends vertically through the centre of the bin from the base of the bin through the opening in the lid of the bin and is fluidly connected to an outlet tube (49) near the top The shaft of the auger system is operatively connected to a motor (50) positioned external to the bin under the opening of the hopper bottom and passes through the opening in the hopper bottom and extends substantially the length of the auger tube. The auger tube comprises one or more opening near the bottom of the tube to allow grain to enter the auger system and be transported up to the outlet tube. The outlet tube (55) extends down the exterior of the bin and is optionally fluidly connected an accumulator tube (60). Optionally, the accumulator tube is fitted with a glass panel. In certain embodiments, the outlet tube (55) or accumulator (60) is reversibly sealed with a release trap (65). The release trap (65) is optionally a spring mounted trapped door that can be slid out to allow free flow of material. Optionally, the outlet may be equipped with a flexible guide (67)

In this illustrative embodiment, the bin is mounted on a support structure. In certain embodiments the support structure (56) comprises support legs and, optionally cross-beams and may be covered or blocked in with one or more maintenance doors (57). The maintenance door may be hinged and swung open and closed or alternatively completely removable. In these illustrated non-limiting embodiments, the bin further comprises a grain inlet. The inlet may be fluidly connected to a fill pipe (70).

The bin may be further provided with one or more vent pipes (75).

The dispenser of the present invention further comprises a user interface (80) for selecting amount of the bulk free flowing particulate material to be dispensed and optionally a means to input payment. The user interface may include one or more display screens and/or one or more input devices such as for example a touch screen, a keypad, voice-activated input device and/or the like.

In some embodiments, the user interface comprises a means to input payment (i.e., a payment interface).

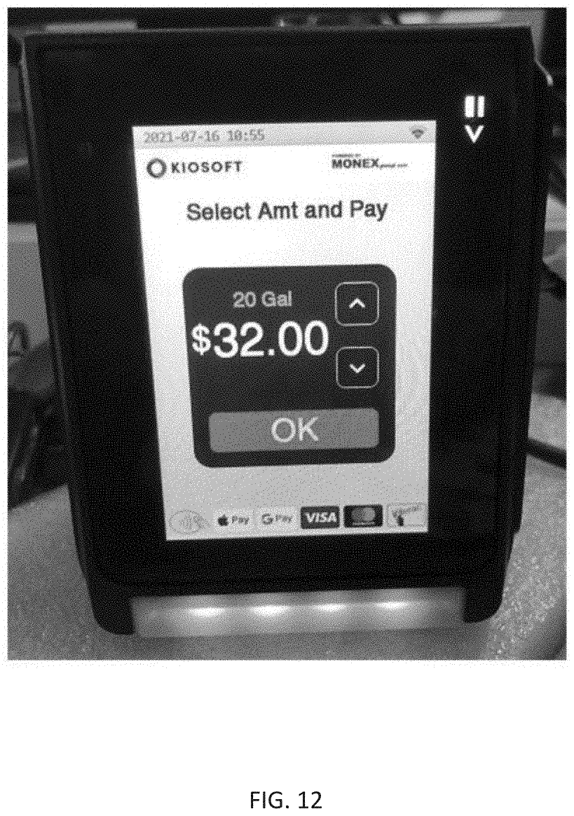

The payment interface may include a currency collection machine, a debit/credit card terminal and/or mobile/digital payment options such as Apple Pay. In certain embodiments, the payment interface comprises a debit/credit card terminal and/or mobile/digital payment options. An exemplary payment interface is illustrated in FIG. 12.

In embodiments which allow debit/credit card terminal and/or mobile/digital payment options, the dispenser of the present invention comprises a payment system and has communication capabilities. The communication may be via a local area network (LAN), a wide area network (WAN), a mobile or cellular communication network, an extranet, an intranet, the internet and/or the like. In certain embodiments, the dispenser of the present invention has wireless communication capabilities.

In embodiments which allow debit/credit card and/or mobile/digital payment options, the payment system communicates with a payment processor (e.g., financial institution, credit card company or 3^{rd} party payment processor such as Monex Group) to process the payment and upon confirmation of payment, the payment system communicates with the operation control means to dispense the amount of product purchased. Self-serve point of sale (POS) systems for use in the present invention are known in the art and are commercially available. For example, the Ultra VX payment kiosk system by KIOSOFT enables self-serve Interac and credit card payments and is waterproof, tamperproof, dirtproof, and operates under any weather condition. In certain embodiments, dispenser of the present invention utilizes a contactless POS system and accepts debit card, credit card and mobile/digital payment options.

The dispenser of the present invention further comprises operation control means (e.g. programmable logic controller (PLC)) for operating the conveying unit in accordance with input from said user interface and, optionally input from payment system and/or one or more sensors. The operation control means comprises a processor and a computer-readable storage medium that comprises one or more programming instructions that, when executed, cause the processor to: receive an indication of amount of bulk free-flowing particulate materials to be dispensed; optionally, receive confirmation from the POS system that payment has been made; and cause operation of the conveying unit for a sufficient period of time to dispense the amount of bulk free-flowing particulate materials requested.

In certain embodiments, the operation control means receives further input from one or more sensors in the dispenser. The sensors may include, for example, a sensor to determine the amount (by volume or by weight) of bulk free flowing particulate materials dispensed. In such embodiments, the computer-readable storage medium of the operation control means comprises one or more programming instructions that, when executed, cause the processor to: receive an indication of amount of bulk free-flowing particulate materials to be dispensed; optionally, receive confirmation from the POS system that payment has been made; and cause operation of the conveying unit by causing the motor of the conveying unit to start; receive input from one or more sensors that the amount of bulk free-flowing particulate materials requested has been dispensed; cause operation of the conveying unit to stop by causing the motor of the conveying unit to stop.

The dispenser of the present invention may further comprise one or more sensors indicating level of free-flowing particulate material in the bin. In such an embodiment, the operation control means may send a notification when bin is low and requires refilling.

In certain embodiments, the dispenser of the present invention is solar powered.

Also provided are methods of using the dispenser to purchase free-flowing particulate material, such as animal feed. In certain embodiments, the method of using the dispenser is as follows: select the quantity of material to be dispensed using the user interface; pay for the material using the payment interface on the user interface; when there is order ready signal, position container under the outlet and open the outlet.

1. An automated dispenser of bulk free flowing particulate material, the automated dispenser comprising:
a storage bin for the bulk free flowing particulate material;
a conveying unit for conveying the bulk free flowing particulate material from the storage bin to an outlet;
a user interface for selecting amount of said bulk free flowing material to be dispensed and optionally a means to input payment; and
operation control means for operating the conveying unit in accordance with input from said user interface.

2. The automated dispenser of claim 1, wherein said dispenser is for dispensing animal feed.

3. The automated dispenser of claim 1, wherein conveying unit is an auger system.

4. The automated dispenser of claim 1, further comprising a payment system for debit card, credit card and mobile/digital payment; said payment system operably associated with the user interface and operation control means and capable of communication with a payment processor.

5. The automated dispenser of claim 4, wherein the payment system is a contactless self-serve point of sale system.

6. The automated dispenser of claim 5, wherein the operation control means comprises a processor and a computer-readable storage medium that comprises one or more programming instructions that, when executed, cause the processor to: receive an indication of amount of bulk free-flowing particulate materials to be dispensed; receive confirmation from the POS system that payment has been made; and cause operation of the conveying unit for a sufficient period of time to dispense the amount of bulk free-flowing particulate materials requested.

7. The automated dispenser of claim 6, wherein the dispenser comprises one or more sensors and the operation control means receives further input from one or more sensors in the dispenser.

8. The automated dispenser of claim 7, wherein the computer-readable storage medium of the operation control means comprises one or more programming instructions that, when executed, cause the processor to: receive an indication of amount of bulk free-flowing particulate materials to be dispensed; receive confirmation from the POS system that payment has been made; and cause operation of the conveying unit by causing the motor of the conveying unit to start; receive input from one or more sensors that the amount of bulk free-flowing particulate materials requested has been dispensed; cause operation of the conveying unit to stop by causing the motor of the conveying unit to stop.
